(19) United States
(12) Patent Application Publication
(10) Pub. No.: US 2008/0114127 A1
(43) Pub. Date: May 15, 2008

(54) METHOD FOR PRODUCING BRANCHED POLYPHOSPHONATES WITH NARROW MOLECULAR WEIGHT DISTRIBUTIONS

(76) Inventors: Dieter Freitag, Chelmsford, MA (US); Pin Go, Lowell, MA (US); Lothar Franke, Webster, MA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/380,089

(22) Filed: Apr. 25, 2006

Related U.S. Application Data
(60) Provisional application No. 60/674,424, filed on Apr. 25, 2005.

(51) Int. Cl. C08G 79/06; C08L 85/02

(52) U.S. Cl. 525/150; 528/167

(57) ABSTRACT

Disclosed are new compositions consisting of branched polyphosphonates and specific additive compositions that exhibit superior resistance to degradation due to exposure to air, high temperature, moisture or combinations thereof. Also disclosed are polymer mixtures or blends comprising these branched polyphosphonates/additive compositions and commodity and engineering plastics and articles produced therefrom. Further disclosed are articles of manufacture produced from these materials, such as fibers, films, coated substrates, moldings, foams, fiber-reinforced articles, or any combination thereof.

This application claims priority to U.S. Provisional Application No. 60/674,424 filed Apr. 25, 2005, titled Method for Producing Branched Polyphosphonates with Narrow Molecular Weight Distributions, the contents of which are incorporated herein by reference.

### TECHNICAL FIELD

The present invention relates generally to a method to produce branched polyphosphonates with narrow molecular weight distribution by selective removal of low molecular species. The branched polyphosphonates with a narrow molecular weight distribution exhibit a favorable combination of properties. It also relates to these branched polyphosphonates with narrow molecular weight distribution, and polymer mixtures or blends comprising these narrow molecular weight distribution branched polyphosphonates and other polymers, and flame retardant coatings and articles produced therefrom.

### BACKGROUND

Recently, the development of a method to produce branched polyphosphonates with a superior combination of properties was disclosed (“Branched Polyphosphonates that Exhibit an Advantageous Combination of Properties, and Methods Related Thereto”, 2004 0167284 A1, published Aug. 26, 2004, Ser. No. 10/374,829, filing date Feb. 24, 2003). This method produces branched polyphosphonates with an exceptional combination of properties. However in some cases, the synthesis of these materials can lead to molecular weight distributions that are broader (i.e. higher dispersity) than desirable for some applications. The lower molecular weight species present in the distribution can negatively impact properties of importance such as toughness, film forming characteristics, and thermo-oxidative stability.

Fractionation is the process of selective removal of certain molecular weight species from a distribution of molecular weights present in a polymer. The most common method of fractionating a polymer is by solubility whereby a polymer is dissolved in a solvent and a non solvent is added until a slight turbidity develops. Fractionation of polymers is a widely known technique. For example, see Fred W. Billmeyer in Textbook of Polymer Science 2^{nd} Edition, Wiley Interscience, New York 1971, pgs 45-52. However, due to the unique and complex solubility characteristics of many polymers, the specific solvent(s) and concentration ranges to provide effective fractionation are not readily apparent or easy to predict.

### SUMMARY OF THE INVENTION

In view of the above, there is a need for a process to provide branched polyphosphonates with narrow molecular distributions that provide an improved combination of film forming characteristics, thermo-oxidative stability and toughness. Therefore a process to selectively remove the low molecular weight components of the as-synthesized branched polyphosphonates is disclosed herein.

It is another object of the present invention to formulate polymer mixtures or blends comprising these fractionated branched polyphosphonates and commodity or engineering plastics. A polymer mixture or blend comprises at least one fractionated branched polyphosphonate of the present invention with at least one other polymer, which may be a commodity or engineering plastic, such as polycarbonate, polyacrylate, polyacrylonitrile, polyester, polyamide, polystyrene, polyurethane, polyurea, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, cellulose polymer, or any combination thereof. The polymer mixture or blend may be produced via blending, mixing, or compounding the constituent polymers. Due to the fractionated branched polyphosphonates of the present invention, the resulting polymer mixture or blend exhibits exceptional flame resistance (e.g., higher LOI), heat stability (minimal Tg depression), and low color and good toughness.

It is yet another object of the present invention to produce articles of manufacture from these fractionated branched polyphosphonates or from polymer mixtures or blends comprising these fractionated branched polyphosphonates and other polymers. The branched polyphosphonates and polymer mixtures or blends of the present invention can be used as coatings or they can he used to fabricate free-standing films, fibers, foams, molded articles, and fiber reinforced composites.

The above summary of the present invention is not intended to describe each illustrated embodiment or every implementation of the present invention. The detailed description, which follows, particularly exemplifies these embodiments.

### DETAILED DESCRIPTION OF EXEMPLARY EMBODIMENTS

The present invention pertains to a method to selectively remove the low molecular weight components that can be present in branched polyphosphonates due to their method of synthesis. For some applications it is desirable to remove these low molecular weight species to provide a fractionated branched polyphosphonate with film forming characteristics, thermo-oxidative stability and toughness.

The fractionated branched polyphosphonates can also have an advantageous combination of fire resistance, low color and low haze. The term “fractionated” as used herein means that the branched polyphosphonate has been treated with a solvent that selectively removes the low molecular weight species that was present in the as-synthesized material. The terms “flame retardant”, “flame resistant”, “fire resistant” or “fire resistance”, as used herein, mean that the composition exhibits a limiting oxygen index (LOI) of at least 27. The phrase “thermo-oxidative stability”, as used herein, means that the fractionated polyphosphonate exhibits less of a reduction in molecular weight, toughness and has less of a tendency to drip in a flame than the same polyphosphonate prior to fractionation when exposed to high temperature, air, moisture and combinations thereof. Molecular weight, and molecular weight distribution as used herein, were determined by relative viscosity and gel permeation chromatography (GPC). It is well known that relative viscosity is a measurement that is indicative of the molecular weight in a polymer. It is also well known GPC provides information about the molecular weight and molecular weight distribution of a polymer. It is well known that the molecular weight distribution of a polymer is important to properties such as thermo-oxidative stability (due to the presence of end groups), toughness, melt flow and fire resistance (low molecular weight polymers drip more when burned). The term “toughness”, as used herein, is determined qualitatively on a molded specimen.

The branched polyphosphonates were prepared according to the published patent application entitled “Branched Polyphosphonates that Exhibit an Advantageous Combination of Properties, and Methods Related Thereto” (2004 0167284 A1, published Aug. 26, 2004, Ser. No. 10/374,829, filing date Feb. 24, 2003). According to the published patent application, the reaction to prepare the branched polyphosphonates is conducted at a high temperature in the melt under vacuum. The reaction temperature and pressure are adjusted at several stages during the course of the reaction. A stoichiometric imbalance (e.g., molar ratio) of the phosphonic acid diaryl ester to the bisphenol and the phosphonium catalyst of up to about 20 mole % excess of either the phosphoric acid diaryl ester or the bisphenol can be used to prepare the branched polyphosphonates.

Several approaches were investigated to effect selective fractionation of the branched polyphosphonates. These include the two solvent approach in which the polymer is dissolved in a solvent and a non solvent added to precipitate a fraction. This is usually repeated several times. The other approach involved using one solvent that would selective dissolve only the low molecular weight species. A variety of solvents were investigated for use in the techniques mentioned above. Preferred solvents to selectively dissolve only the low molecular weight species include polar aprotic solvents such as, but not limited, to N,N-dimethylacetamide, N-methyl-2-pyrrolidinone, N,N-dimethylacetamide, and aromatic and aliphatic nitrile solvents. A variety of aromatic and aliphatic nitrile solvents are suitable, but it is preferred that they are liquid at room temperature. More preferred aromatic and aliphatic nitrile solvents include, but are not limited to, acetonitrile, propionitrile, butyronitrile, isoamylnitrile and benzonitrile. Acetonitrile is most preferred. Preferred solvents to dissolve the branched polyphosphonates include halogenated solvents such as methylene chloride, chloroform, dichloroethane, trichloroethane and tetrachloroethane and tetrahydrofuran (THF). Preferred non solvents include acetone, methanol, ethanol and isopropanol.

To evaluate the results of the fractionation process, gel permeation chromatography (GPC) was used. Comparison of the as-synthesized and fractionated polyphosphonates was performed using a polycarbonate standard. (Scientific Polymer Products, Inc., catalog number 0359, polycarbonate resin lot number 7, 22,600 g/mole and 12,100 g/mole, dispersity 1.87).

The resulting compositions comprising the fractionated branched polyphosphonates of the present invention were evaluated for stability to combinations of temperature, moisture and air and compared to the same branched polyphosphonates (without fractionation). The compositions comprising the fractionated branched polyphosphonates exhibited superior resistance to degradation as measured by the changes in molecular weight, toughness and tendency to drip when exposed to a flame.

The compositions comprising the fractionated branched polyphosphonates of the present invention were also used to produce polymer mixtures or blends with commodity and engineering plastics having advantageous characteristics. The term “polymer mixtures or blends”, as used herein, refers to a composition that comprises at least one fractionated branched polyphosphonate of the present invention and at least one other polymer. There term “other polymer”, as used herein, refers to any polymer other than the fractionated branched phosphonate of the present invention. These other polymers may be commodity or engineering plastics such as polycarbonate, polyacrylate, polyacrylonitrile, polyester, polyamide, polystyrene (including high impact strength polystyrene), polyurethane, polyurea, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, cellulose polymer, or any combination thereof (commercially available from, for example, GE Plastics, Pittsfield, Mass.; Rohm & Haas Co., Philadelphia, Pa.; Bayer Corp.—Polymers, Akron, Ohio; Reichold; DuPont; Huntsman LLC West Deptford, N.J.; BASF Corp., Mount Olive, N.J.; Dow Chemical Co., Midland, Mich; GE Plastics; DuPont; Bayer; Dupont; ExxonMobil Chemical Corp., Houston, Tex.; ExxonMobil; Mobay Chemical Corp., Kansas City, Kans.; Goodyear Chemical, Akron, Ohio; BASF Corp.; 3M Corp., St. Paul, Minn.; Solutia, Inc., St. Louis, Mo.; DuPont; and Eastman Chemical Co., Kingsport, Tenn., respectively). The polymer mixtures or blends may be produced via blending, mixing, or compounding the constituent materials.

It is contemplated that fractionated branched polyphosphonates or the polymer mixtures or blends of the present invention may comprise other components, such as fillers, surfactants, organic binders, polymeric binders, crosslinking agents, coupling agents, anti-dripping agents, colorants, inks, dyes, antioxidants or any combination thereof.

The fractionated branched polyphosphonates or the polymer mixtures or blends of the present invention can be used as coatings or they can be used to fabricate articles, such as free-standing films, fibers, foams, molded articles and fiber reinforced composites. These articles may be well-suited for applications requiring fire resistance.

The fractionated branched polyphosphonates or the polymer mixtures or blends of the present invention are generally self-extinguishing in that they stop burning when removed from a flame. Any drops produced by melting these fractionated branched polyphosphonates or the polymer mixtures or blends in a flame stop burning almost instantly and do not readily propagate fire to any surrounding materials. Moreover, these fractionated branched polyphosphonates or the polymer mixtures or blends do not evolve noticeable smoke when a flame is applied.

In summary, the fractionated branched polyphosphonates exhibit a superior combination of thermo-oxidative stability and toughness compared to the as-prepared polyphosphonates. The fractionated branched polyphosphonates and the polymer mixtures or blends of the present invention also exhibit superior stability during melt processing. The fractionated polymer exhibit outstanding flame resistance and a more advantageous combination of heat stability (e.g., Tg), toughness, hydrolytic stability, low color and low haze as compared to the as-prepared branched polyphosphonates. Such improvements make these materials useful in applications in the automotive and electronic sectors that require outstanding fire resistance, high temperature performance, and high toughness.

### EXAMPLES

Having generally described the invention, a more complete understanding thereof may be obtained by reference to the following examples that are provided for purposes of illustration only and do not limit the invention.

### Example 1

### Synthesis of a Branched Polyphosphonate Designated as FX 200-1

The branched polyphosphonate was prepared according to the procedure in the published patent application entitled “Branched Polyphosphonates that Exhibit an Advantageous Combination of Properties, and Methods Related Thereto” (2004 0167284 A1, published Aug. 26, 2004, Ser. No. 10/374,829, filing date Feb. 24, 2003).

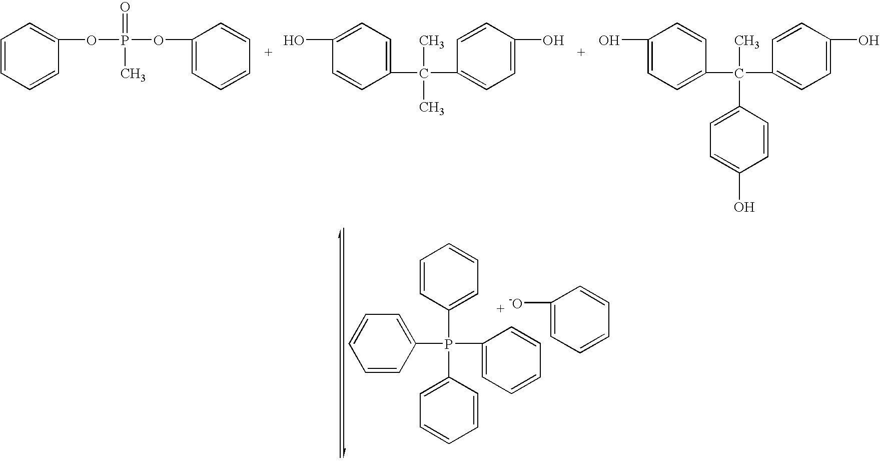

### Branched Polyphosphonate

A 250 ml, three neck round bottom flask equipped with a mechanical stirrer, distillation column (10 cm) filled with hollow glass cylinders, condenser, and vacuum adapter with control valve was flushed with nitrogen for 0.5 hour. Methyldiphenoxyphosphine oxide (44.57 g, 0.1795 moles), 2,2-bis(4-hydroxyphenyl)propane (bisphenol A), (33.28 g, 0.1458 moles), tetraphenylphosphonium phenolate (0.0127 g, 2.77×10⁻⁵ moles) and 1,1,1-tris(4-hydroxyphenyl)ethane (0.460 g, 0.0015 moles) were placed into the flask and the flask was flushed with nitrogen again. The distillation column was wrapped with heating tape and heated. The reaction vessel was placed in an oil bath and heated to 250° C. until the solids in the flask melted. The reaction mixture was further heated and the vacuum was adjusted at various times during the reaction as indicated in Table 2 below.

TABLE 2
Reaction Parameters for Example 1

| Time after | | | |
|---|---|---|---|
| starting | Oil Bath Temp. | Column Temp. | Vacuum |
| (minutes) | (° C.) | (° C.) | (mm Hg) |
| 0 | 12 | — | 760 |
| 10 | 153 | 133 | 695 |
| 25 | 252 | 131 | 690 |
| 55 | 250 | 130 | 195 |
| 80 | 250 | 130 | 141 |
| 120 | 250 | 130 | 96 |
| 145 | 250 | 130 | 96 |
| 150 | 250 | 121 | 96 |
| 160 | 250 | 104 | 72 |
| 195 | 250 | 100 | 44 |
| 225 | 250 | 100 | 19 |
| 235 | 250 | 100 | 9 |
| 250 | 250 | 118 | 1.6 |
| 270 | 270 | 107 | 1.5 |
| 295 | 270 | 100 | 1.5 |
| 315 | 305 | 101 | 1.4 |
| 320 | 305 | 127 | 1.4 |
| 340 | 305 | 150 | 1.3 |
| 360 | 305 | 180 | 1.2 |
| 385 | 305 | 180 | 1.2 |
| 390 | Stopped | Stopped | Stopped |

During the coarse of this reaction 39.21 g of distillate was collected. At the end of the reaction there was a noticeable increase in the viscosity of the polymer melt. The distillation column was removed from the apparatus and additional tetraphenylphosphonium phenolate catalyst (0.0127 g, 4.3×10⁻⁶ moles) was added. Full vacuum was applied and the reaction was heated as indicated in Table 3.

TABLE 3
Reaction Parameters for Example 1 POST REACTION

| Time after starting | Oil Bath Temp. | Vacuum |
|---|---|---|
| (minutes) | (° C.) | (mm Hg) |
| 0 | 15 | 2.0 |
| 10 | 161 | 1.9 |
| 20 | 221 | 1.7 |
| 25 | 263 | 1.6 |
| 35 | 304 | 1.6 |
| 60 | 305 | 1.5 |
| 90 | 305 | 1.4 |
| 110 | 305 | 1.3 |
| 155 | 305 | 1.1 |
| 170 | 305 | 1.1 |
| 200 | 305 | 1.1 |
| 230 | 305 | 1.1 |
| 250 | 305 | 1.1 |
| 270 | 305 | 1.1 |
| 295 | 305 | 1.0 |
| 320 | 305 | 1.1 |
| 335 | 305 | 1.1 |
| 340 | Stopped | Stopped |

During this post reaction 1.1 g of distillate was collected. Upon cooling, the viscous, pale yellow melt began to solidify. As it solidified, the solid was tough and peeled glass off of the inner walls of the flask. After further cooling to room temperature, the flask was broken to isolate the solid. A 0.5% solution of the polymer in methylene chloride exhibited a relative viscosity of 1.38 at 25° C.

### Example 2

### Synthesis of a Branched Polyphosphonate Designated as 1372-8

The branched polyphosphonate was prepared according to the procedure in the published patent application entitled “Branched Polyphosphonates that Exhibit an Advantageous Combination of Properties, and Methods Related Thereto” (2004 0167284 A1, published Aug. 26, 2004, Ser. No. 10/374,829, filing date Feb. 24, 2004).

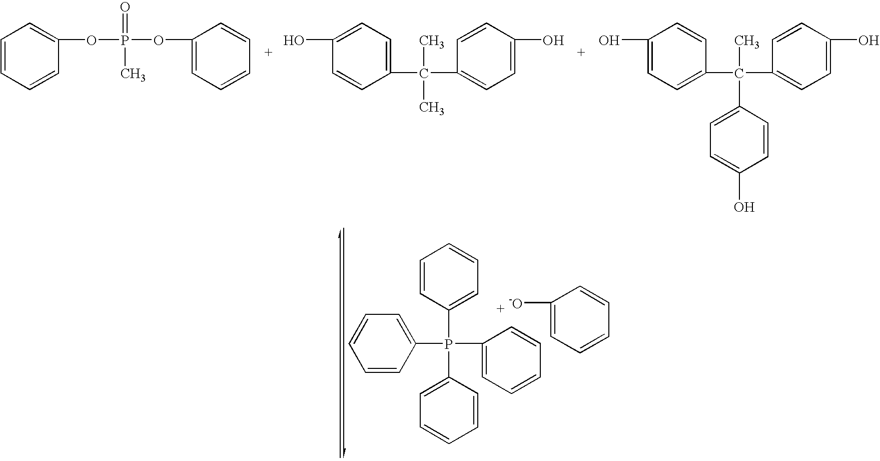

### Branched Polyphosphonate

In this example, the reaction was conducted in a pilot plant using methyldiphenoxyphosphine oxide (1400 g)—because this compound is 97.9% pure as determined by HPLC—the precise amount of this compound is actually (1371 g, 5.52 moles), 2,2-bis(4-hydroxyphenyl)propane (bisphenol A), (1308 g, 5.737 moles), tetraphenylphosphonium phenolate (0.451 g, 9.8×10⁻⁴ moles and 1,1,1-tris(4-hydroxyphenyl)ethane (6.4 g, 0.021 moles). The reaction was thermally treated following the protocol described in Table 1 as closely as possible.

Upon cooling, a near colorless melt was obtained. A 0.5% solution of the polymer in methylene chloride exhibited a relative viscosity of 1.4 at 25° C.

### Example 3

### Fractionation of Branched Polyphosphonate of Example 1

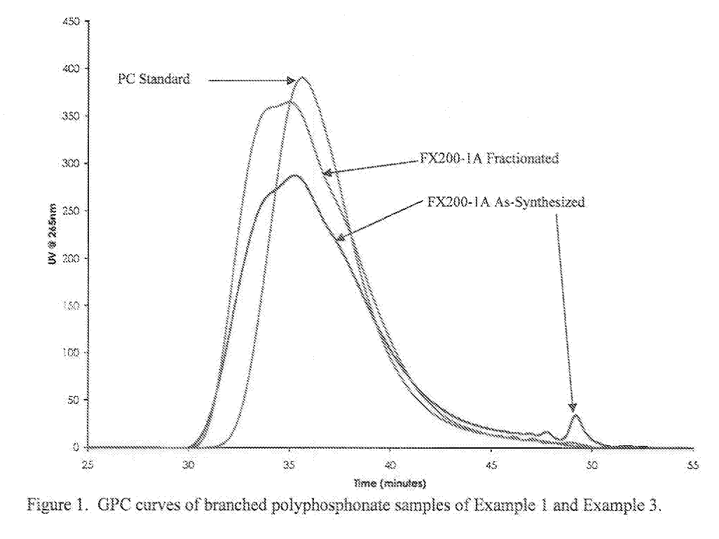

The branched polyphosphonate of example 1 (FX200-1A) was placed in acetonitrile at room temperature and allowed to stand for 15 hours. The solid polymer was filtered from the solution and dried. The GPC curves of the polymer before and after extraction are shown below in FIG. 1 below. The standard used for the GPC experiments was a polycarbonate standard (Scientific Polymer Products, Inc. catalog number 0359, polycarbonate resin lot number 07, M_{w} 22,600 g/mole and Mₙ 12,100 g/mole, dispersity 1.87). From the GPC curves in FIG. 1, it is clear that the low molecular weight species present in the as-prepared FX-200-1A sample is removed (peak at elution time near 50 minutes). The data from the GPC experiment is presented in Table 1. The removal of the low molecular weight species by the extraction process is also evident by the increase in Mₙ and the decrease in dispersity.

TABLE 1
GPC Results for Example 3

| Sample | Mₙ | M_{w} | M_{z} | Mₚ | Disperity |
|---|---|---|---|---|---|
| FX-200-1A | 8896 | 28832 | 48102 | 28471 | 3.24 |
| (As-Synthesized) | | | | | |
| FX-200-1A | 14065 | 30684 | 47341 | 31225 | 2.18 |
| (Fractionated) | | | | | |
| PC Standard* | 12100 | 22600 | 31318 | 26663 | 1.87 |

*Scientific Polymer Products, Inc., catalog number 0359, polycarbonate resin lot number 07, M_{w} 22,600 g/mole and Mₙ 12,100 g/mole, dispersity 1.87.

### Example 4

### Fractionation of Branched Polyphosphonate of Example 1

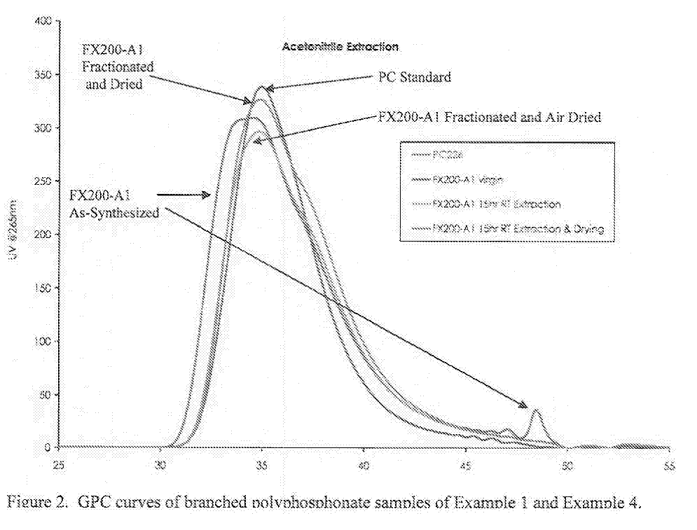

To demonstrate repeatability of the extraction process, the branched polyphosphonate of example 1 (FX200-1A) was placed in acetonitrile at room temperature and allowed to stand for 15 hours. The solid was isolated and in one case allowed to air dry, and in the other case dried for 4 hours at 85° C. under vacuum. The GPC curves of the polymer before and after extraction are shown below in FIG. 2 below. The standard used for the GPC experiments was a polycarbonate standard (Scientific Polymer Products, Inc., catalog number 0359, polycarbonate resin lot number 07, M_{w} 22,600 g/mole and Mₙ 12,100 g/mole, dispersity 1.87). From the GPC curves in presented in Table 2. The removal of the low molecular weight species by the extraction process is also evident by the increase in Mₙ and the decrease in dispersity.

TABLE 2
GPC Results for Example 4.

| Sample | Mₙ | M_{w} | M_{z} | Mₚ | Disperity |
|---|---|---|---|---|---|
| FX-200-1A | 8982 | 25537 | 39048 | 30012 | 2.84 |
| (As-Synthesized) | | | | | |
| FX-200-1A | 9212 | 21694 | 32243 | 27288 | 2.35 |
| (Fractionated and | | | | | |
| Air Dried) | | | | | |
| FX-200-1A | 9195 | 21065 | 31138 | 27144 | 2.29 |
| (Fractionated and | | | | | |
| Dried at 85° C.). | | | | | |
| PC Standard* | 12100 | 22600 | 31318 | 26663 | 1.87 |

*Scientific Polymer Products, Inc., catalog number 0359, polycarbonate resin lot number 07, M_{w} 22,600 g/mole and Mₙ 12,100 g/mole, dispersity 1.87

### Example 5

### Fractionation of Branched Polyphosphonate of Example 1

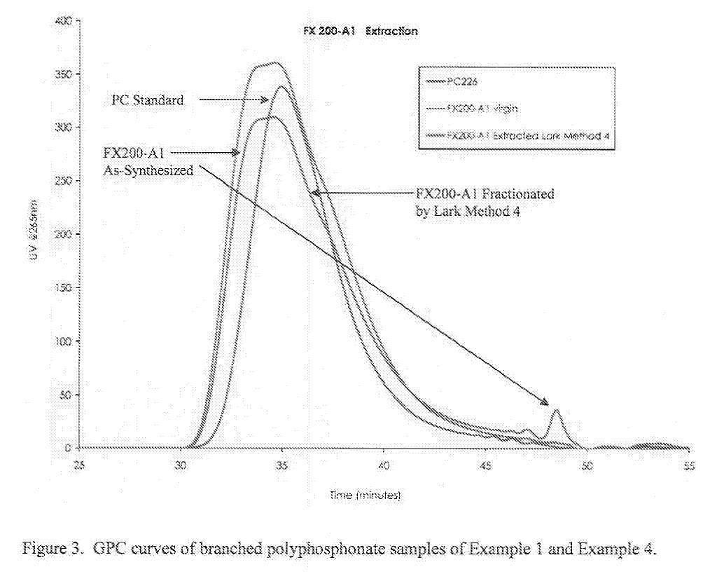

The branched polyphosphonate of example 1 (FX200-1A) was placed in acetonitrile at 4° C. in a refrigerator over the weekend. The liquid was decanted away from the solid and THF was subsequently added and a solution resulted. The cold extraction method is designated as Lark Method 4. The GPC curves of the polymer before and after this extraction process are shown below in FIG. 3 below. The standard used for the GPC experiments was a polycarbonate standard (Scientific Polymer Products, Inc., catalog number 0359, polycarbonate resin lot number 07, M_{w} 22,600 g/mole and Mₙ 12,100 g/mole, dispersity 1.87). From the GPC curves in presented in Table 3. The removal of the low molecular weight species by the extraction process is also evident by the increase in Mₙ and the decrease in dispersity.

TABLE 3
GPC Results for Example 5.

| Sample | Mₙ | M_{w} | M_{z} | Mₚ | Disperity |
|---|---|---|---|---|---|
| FX-200-1A (As- | 8982 | 25537 | 39048 | 30012 | 2.84 |
| Synthesized) | | | | | |
| FX-200-1A | 12479 | 26794 | 39768 | 29696 | 2.15 |
| (Fractionated by Lark | | | | | |
| Method 4) | | | | | |
| PC Standard* | 12100 | 22600 | 31318 | 26663 | 1.87 |

*Scientific Polymer Products, Inc., catalog number 0359, polycarbonate resin lot number 07, M_{w} 22,600 g/mole and Mₙ 12,100 g/mole, dispersity 1.87

We claim:

1. A method to fractionate branched polyphosphonates wherein the polymer is placed in a polar aprotic solvent, allowed to stand and the solvent is decanted from the solid polymer.

2. The method of claim 1, wherein the solvent is a nitrile-based solvent of the following general formula; R−CN. Wherein R represents an aromatic or aliphatic radical.

3. The method of claim 2, wherein R is CH₃.

4. Fractionated branched polyphosphonates produced by the method of claim 1.

5. A polymer blend or mixture, comprising:
a) at least one fractionated branched polyphosphonate prepared according to of claim 1; and
b) at least one other polymer.

6. A polymer mixture or blend according to claim 5, wherein said other polymer is a polycarbonate, polyacrylate, polyacrylonitrile, polyester, polyamide, polystyrene, polyurethane, polyurea, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, polyether, polyphenylene oxide, cellulose polymer, or any combination thereof.

7. A polymer mixture or blend according to claim 6, wherein said other polymer consists essentially of polycarbonate.

8. An article of manufacture produced from the fractionated branched polyphosphonate of claim 1.

9. An article of manufacture produced from the polymer mixture or blend of claim 5.

10. An article of manufacture according to claim 8, wherein the article is a fiber, a film, a coating, a molding, a foam, a fiber reinforced article, or any combination thereof.

11. An article of manufacture according to claim 9, wherein the article is a fiber, a film, a coating, a molding, a foam, a fiber reinforced article, or any combination thereof.
